(19) United States
(12) Patent Application Publication
(10) Pub. No.: US 2017/0123225 A1
(43) Pub. Date: May 4, 2017

(54) DURABLE QUICK INSTALL/RELEASE ERGONOMICALLY EFFICIENT LIGHT OBSCURING COVER FOR CONTROLLING RETICLE BRIGHTNESS IN FIBER OPTIC MEDIUM LIGHT CONDUIT SIGHTS

(71) Applicant: The United States of America as represented by the Secretary of the Navy, Crane, IN (US)

(72) Inventors: Garry Wieneke, Montgomery, IN (US); Gerry Miller, Bedford, IN (US); Ameer Beitvashahi, Bloomington, IN (US)

(21) Appl. No.: 14/960,760

(22) Filed: Dec. 7, 2015

Related U.S. Application Data
(60) Provisional application No. 62/247,924, filed on Oct. 29, 2015.

(51) Int. Cl. G02B 27/34; F41G 1/34; F41G 1/38; F21V 8/00; G02B 23/14

(52) U.S. Cl. CPC G02B 27/34; G02B 6/0005; G02B 23/14; F41G 1/38; F41G 1/345

(57) ABSTRACT

Exemplary apparatuses and methods are provided which provide an ability for rapid manipulation of a light obscuring cover to control brightness of an optical medium based sight assembly reticle projector. Shapes or portions of an exemplary cover can be formed to provide structural elements oriented, shaped, and positioned within a range of motion distance of a user's normal finger or hand positions on an equipment item, e.g. a weapon, suitable for rapid manipulation or repositioning of the cover by a user while minimizing accidental manipulation or movement. The light obscuring cover may flexibly conform and grip to sections of the sight assembly to cover the fiber optic cable or medium. In one embodiment, the apparatus further comprises a lanyard element configured for attaching the light obscuring cover to the scope and thereby be used to manipulate, locate, adjust, or arrest the cover's motion in relation to the sight assembly.

### CROSS-REFERENCE TO RELATED APPLICATIONS

The present application claims priority to U.S. Provisional Patent Application Ser. No. 62/247,924, filed Oct. 29, 2015, entitled “SHADE STRUCTURE FOR CONTROLLING RETICLE BRIGHTNESS OF FIBER OPTIC SCOPES,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (NC 200,307) is assigned to the United States Government and is available for licensing for commercial purposes. Licensing and technical inquiries may be directed to the Technology Transfer Office, Naval Surface Warfare Center Crane, email: Cran_CTO@navy.mil.

### BACKGROUND AND SUMMARY OF THE INVENTION

The present invention relates to covers for use with a scope to limit the amount of ambient light that may enter a fiber optic cable associated with the scope. The scope uses the ambient light to project a reticle onto an image that a user can see. In times of bright ambient light, or transitioning from an area with low ambient light to brighter ambient light, the abundance of bright ambient light reaching the fiber optic cable can cause the reticle to be too bright for the user. This can strain the user's eyes over long periods of use and make the reticle difficult to see.

A variety of undesirable approaches to limit light into a fiber optic medium or cable used with respect to a reticle in a sight can be used. For example, undesirable or unsuitable covers can be used for limiting an amount of ambient light that reaches a fiber optic medium or cable include bicycle tubes fitted around the scope, Velcro patches can also be run along both sides of the fiber optic cable to allow a third Velcro patch to attach and cover the fiber optic cable, tape, layers of translucent material, and length adjustable covers that attach to a rail on either side of the fiber optic cable. In limited use, these covers can achieve a temporary effect of limiting the amount of ambient light reaching the fiber optic cable. However, for use in field or continuous use settings, e.g. a Desert-combat situation, these approaches are not sufficient.

The use of a bicycle tube is a quick fix for tournament competitions. A user is required to use a sharp knife or scissors to trim the tube to perfectly fit around the scope. The user is then required to fit the tube around the scope, which can easily take longer than five seconds. A benefit of the rubber tube is that it may last for a long period of time; however it is not meant for field conditions, especially in the desert. Sand can get stuck between the rubber tube and the scope, causing extra wear and tear that reduces the usable life of the scope. Second, in field situations the user needs to be able to access the user's tools or sights easily. When transitioning from bright to dark ambient light, such as entering a building, the user needs to be able to quickly and easily remove a cover such as a fiber optic cable cover. The rubber tube takes too long to remove, is clumsy and difficult to manipulate with gloves on, and requires additional time to store.

Use of Velcro tabs was also designed for a quick fix in tournament competitions. A user could take two strips of Velcro and attaches the strips to the scope on either side and along the length of the fiber optic cable. The user could then take a strip of Velcro, attachable to the already emplaced strips, and lays the third strip across the fiber optic cable. This third strip stays in place by attaching to the other two strips. The Velcro method has the potential to be placed and removed quickly, however this method has its own drawbacks. The glue holding the Velcro strips to the scope can melt in high heat, causing the strips to either move or fall off. Further, the Velcro strips on the scope can stick to other Velcro strips on a user's chest when if the user is wearing a other items or clothing with

Velcro on them such as a combat, utility, or hunting vest. Additionally, the user must take time to precisely place the third Velcro strip. If the user improperly places the strip, the user must take time to remove and reattach the Velcro strip, increasing the time that the user is focusing on the weapon and not on the field situation, e.g., a hunting, equipment use situation, or a combat situation. This method also requires the operator to fully remove at least one hand from an equipment item such as a gun when placing the third Velcro strip.

Tape might be used to cover the fiber optic cable as well. This is a quick fix however the lifetime of the tape is very limited and is not suited to use and reuse. The tape can easily be replaced, but doing so during a field situation is not ideal for a variety of reasons including limited weight and storage capacity. Tape also rapidly degrades under a variety of environmental conditions such as heat and humid/exposure to water. A more reusable and durable solution is desirable.

One or more sheets of translucent material might be used to cover the fiber optic cable of the scope, varying the number of sheets depending on the brightness of the ambient light. A drawback of this method is the lack of durability and reusability. The sheets need a means for being affixed and removed from the scope. Ways to do this include taping the sheet to the scope. As with the above methods for limiting the amount of ambient light that may reach the fiber optic cable, this might meet needs for tournament competitions where the user is not concerned with the time it takes to place and remove the sheets. However, in a situation where time is of the essence, a method becomes less useful the longer it takes to achieve its purpose. The retrieving and placing of the sheet and the removal and storage of the sheet take too long to be useful in combat situations which are frequently storage and time/movement constrained.

Embodiments of the invention might include provisions of covers that are fixed in length or adjustable in length or structure and have other structural aspects such as weight reducing slimming of certain sections and extension of other sections into range of motion zones of a user's fingers in in-service hand gripping positions. In some embodiments, length adjustable covers can provide significant advantages as well.

In particular, embodiments of the invention can include a cover, light obscuring structure, or shade that can press and snap fit attach to or engage with a rail on either side of the fiber optic cable or medium providing a quick attaching and releasing structure. Some embodiments of the exemplary cover, shade, or light obscuring structure can further engage and/or slide along the rail allowing it to open and close and, therefore, can vary the length of fiber optic cable exposed to ambient light. A shorter length of fiber optic cable exposed to ambient light can decrease the brightness of the reticle. However, using such an apparatus in field or desert situations can cause sand and dirt to be caught in the rails, jamming up the mobility of the cover and reducing its usefulness. Further, replacing the cover, when necessary, takes more than a few seconds because it is attach to rails. Thus, while in some embodiments a rail approach might be used, a non-rail or sliding cover may also be desirable.

Embodiments of the invention can be formed of strong, lightweight, and heat-resistant materials such as carbon fiber can be used and formed to meet current needs and address existing design and use problems.

Existing approaches to addressing various needs and problems are cost prohibitive, excessively complex, are vulnerable to damage, are not ergonomically effective or efficient, and have a significant size penalty. Moreover, embodiments of the invention also provide a greater strength-to-weight ratio and to being more heat resistant which arises in part due to material selection as well as structural elements and relationships with sight assemblies or scopes vs user hand operating positions they are used with.

According to an illustrative embodiment of the present disclosure, the present disclosure includes an embodiment that comprises a shade or light obscuring structure comprising a section composed of opaque material and sections composed of a tough, lightweight, heat-resistant material. The invention can attach to the scope by conforming to portions of the scope and can be easily removed, including through finger movements within finger range of motion distances, to transition between an installed or lowered state where one or more embodiments limits an amount of ambient light reaching the fiber optic cable and a raised or rapidly removed position allowing more ambient light to reach the fiber optic cable which increases light conveyed by the fiber optic cable into the sight to generate the lighted reticle. A shape of the shade or light obscuring structure can be formed to provide manual engagement sections which are formed to extend away from the slight or scope which are ergonomically efficient with regard to minimizing movement of the user or operator's hands on a weapon and reduce response times in manipulating the shade or light obscuring structure. Standoff distance and position of portions of embodiments of the invention also provide significant advantages over the prior art. Other structural design features minimize accidental movement or manipulation of an exemplary cover.

According to a further illustrative embodiment of the present disclosure, the embodiment can further comprise an opaque material that allows a limited amount of ambient light to pass through it. Another embodiment can include a coating which can minimize sound of the light obscuring structure or cover striking another surface such an equipment item or weapon the cover or light obscuring structure strikes upon rapid removal from the equipment item or weapon via, e.g. a finger movement. Such finger movements can be done with no or minimal repositioning of the user's hand on the equipment item or weapon due to forming of the cover or light obscuring structure with flanges, stand-off sections, and/or sections within a range of motion of the user's hand grip positions on the equipment or weapon.

According to a further illustrative embodiment of the present disclosure, an embodiment can further comprise a lanyard or leash creating a second means of attaching the invention to the scope. The lanyard can keep the light obscuring or shade structure within reach of the user when the invention fully disengages from the scope, allowing the user to easily find and reattach the invention. The lanyard or leash can also provide a structure for a user to identify location of the exemplary cover without use of direct observation.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 shows an exemplary sight assembly in accordance with one embodiment of the invention;

FIG. 2 shows a cross-section of the exemplary FIG. 1 sight assembly in a section plane;

FIG. 3 shows the exemplary FIG. 1 sight assembly and exemplary shade structure;

FIG. 4 shows two views of the exemplary FIG. 3 shade structure showing different sections of the shade structure;

FIG. 5 shows an end view of the exemplary FIG. 3 shade structure;

FIG. 6 shows two perspective views of the FIG. 3 shade structure;

FIG. 7 shows another view of sections of the exemplary FIG. 3 sight assembly and exemplary shade structure when the shade structure is conforming to and gripping the sight assembly;

FIG. 8 shows different sections of the exemplary FIG. 3 shade structure conforming and gripping a first and second exemplary contact location of the exemplary sight assembly;

FIG. 9 shows the exemplary FIG. 3 sight assembly with a sketch of an exemplary shade structure detached and attached to the exemplary sight assembly and a sketch of an exemplary lanyard connecting the exemplary shade structure to said the exemplary sight assembly;

FIG. 10 shows one embodiment where a user can apply an exemplary first force and exemplary second force to disengage an exemplary shade structure from the exemplary sight assembly;

FIG. 11 shows one embodiment where a user could apply either exemplary first force or exemplary second force to an exemplary shade structure 41 to disengage the exemplary shade structure from an exemplary sight assembly;

FIG. 12 shows an exemplary first method for using an exemplary shade structure to control brightness of an exemplary reticle;

FIG. 13 shows a second exemplary method for using an exemplary shade structure to control brightness of an exemplary reticle;

FIG. 14 shows a third exemplary method for using an exemplary shade structure to control brightness of an exemplary reticle 61; and

FIG. 15 shows a fourth exemplary method for using an exemplary shade structure to control brightness of an exemplary reticle.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

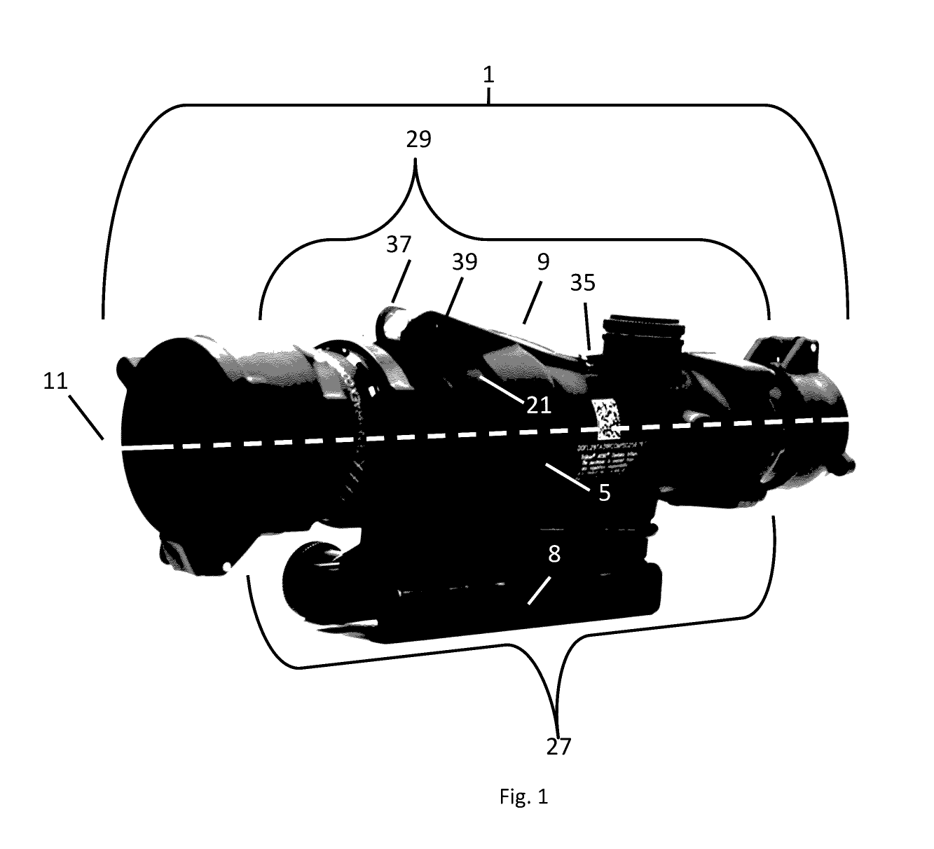

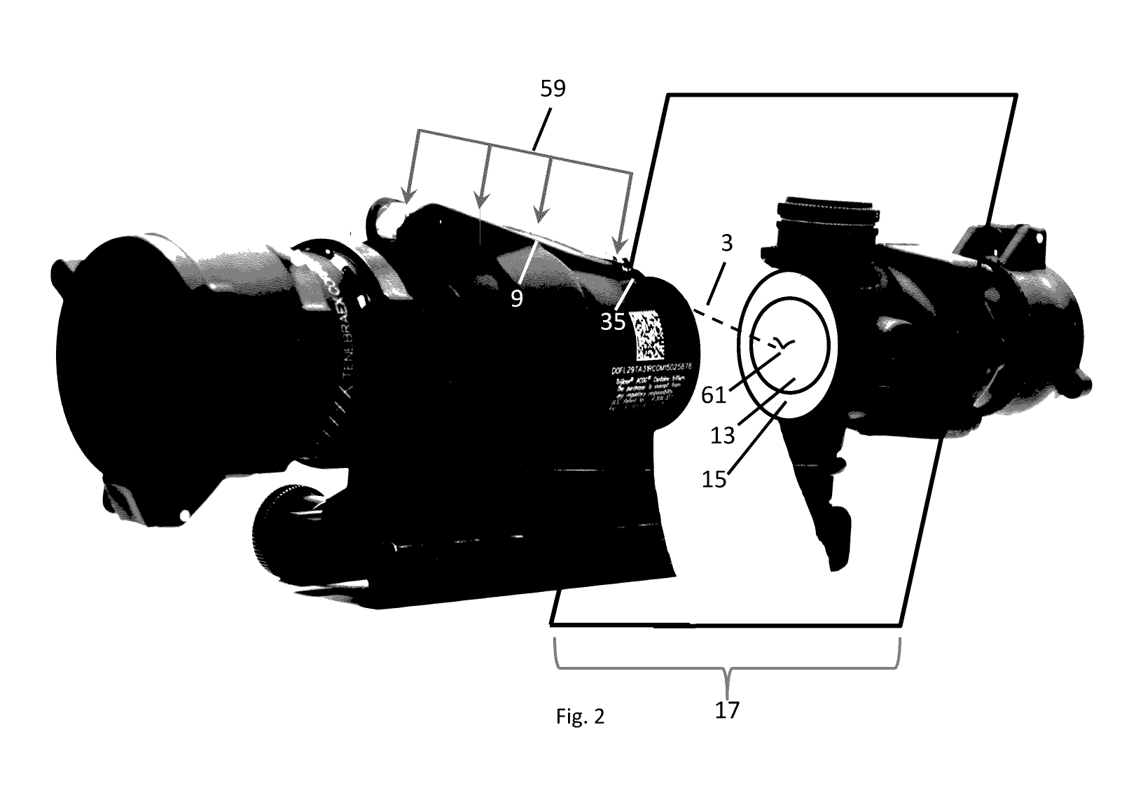

FIG. 1 shows an embodiment of an exemplary sight assembly 1 that an exemplary shade structure 41 (not shown in FIG. 1) may attach to. The sight assembly 1 comprises a sight housing 5, a mounting section 8 formed onto a lower section 27 of the sight housing that is adapted to couple the sight assembly 1 with another structure (such as a firearm or a tripod), and a fiber optic housing comprising a first wall section 37 and a second wall 39 section that are formed onto and extend away from an upper section 29 of the sight housing 5. The sight assembly 1 further comprises a fiber optic line 9 that is disposed between the first wall section 37 and the second wall section 39 and extends into the sight housing 5 through an aperture 35 in the sight housing 5, a plurality of lenses that includes a first lens 13 disposed within a hollow cavity 15 of said sight housing 5 that lies along an optical axis 11. The fiber optic line 9 is adapted to convey light 3 from an external section of the sight assembly 1 into the hollow cavity 15 of the sight assembly 1 and convey such light into a reticle (not shown but see FIG. 2, reticle 61) or aiming point on one of the plurality of lenses (not shown, but see FIG. 2, first lens 13) thereby providing a lighted reticle point.

FIG. 2 shows a section plane 17 of the FIG. 1 exemplary sight assembly 41, wherein lies a first lens 13 of the sight assembly 1. The reticle 61 is created when the fiber optic line 9 absorbs ambient light 59 and projects the absorbed light 3 onto the first lens 13. The brightness of the reticle 61 is dependent on the brightness of ambient light 59 absorbed and surface area of fiber optic line 9 exposed to the ambient light 59. Various exemplary methods for controlling the brightness of the absorbed light 3 conveyed by the fiber optic line 9 and subsequently projected as the reticle 61 onto the first lens 13 are discussed below.

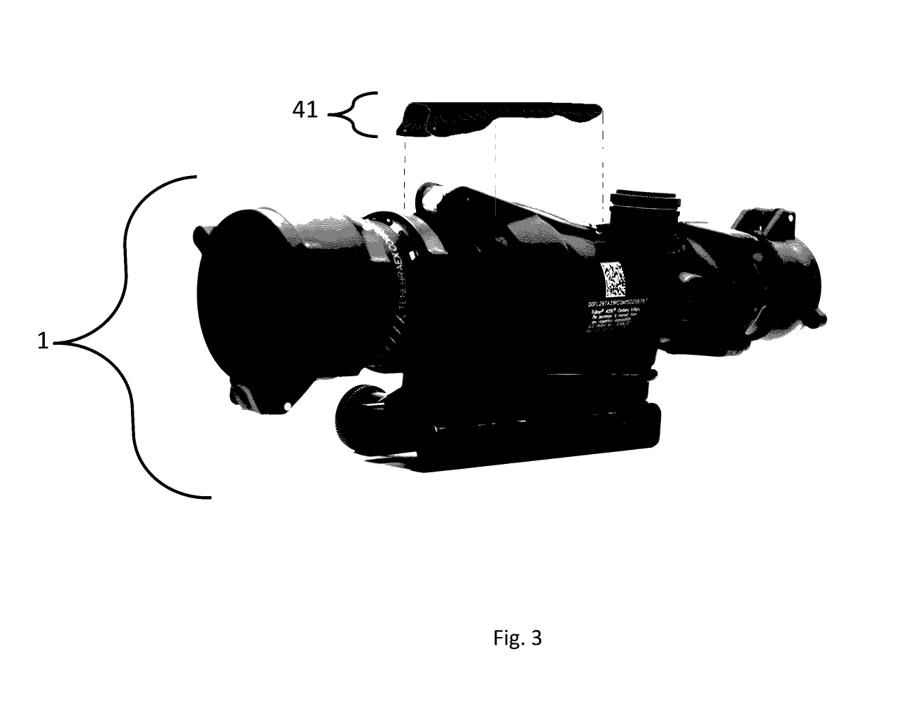

FIG. 3 shows a picture of the Figs, 1 and 2 sight assembly 1 that an exemplary shade structure 41 may attach to. The exemplary shade structure 41 is shown in a first position above the sight assembly 1. The shade structure 41 can be oriented and translated such that the shade structure 41 conforms and attaches to portions of the sight housing 5 and to the fiber optic line 9, discussed below.

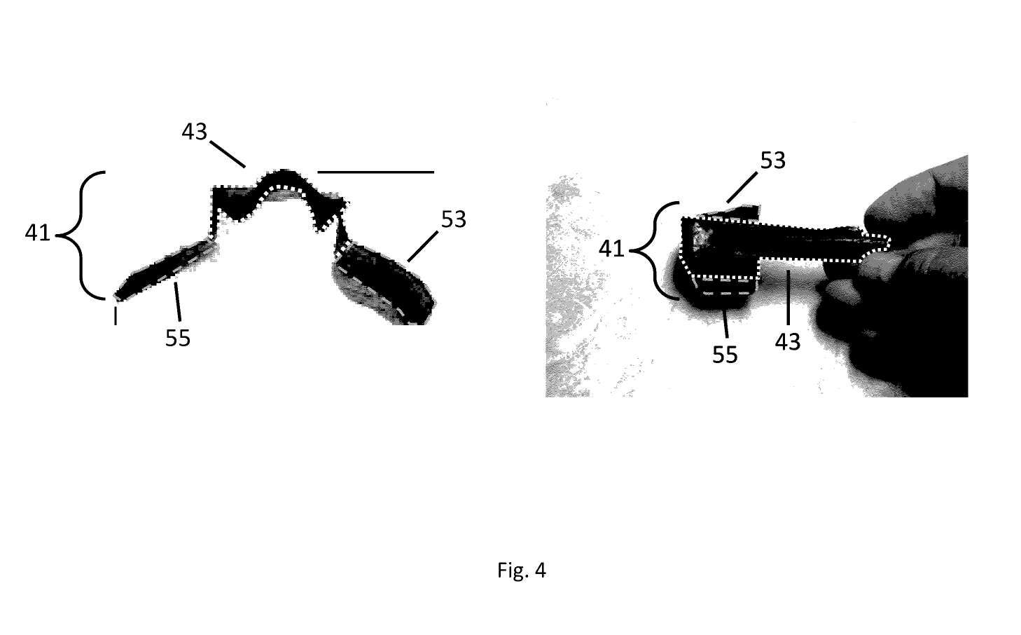

FIG. 4 shows two views of an exemplary shade structure 41 that may be used in controlling the brightness of the reticle 61. The shade structure 41 comprises a first, second, and third section 53, 43, 55. The first and third sections 53, 55 are formed such that portions of some of the sections can couple with said sight housing 5 walls via an interference fit. The second section 43 is formed to fit over the over the fiber optic line 9 and the first and second wall sections 37, 39 of the sight assembly.

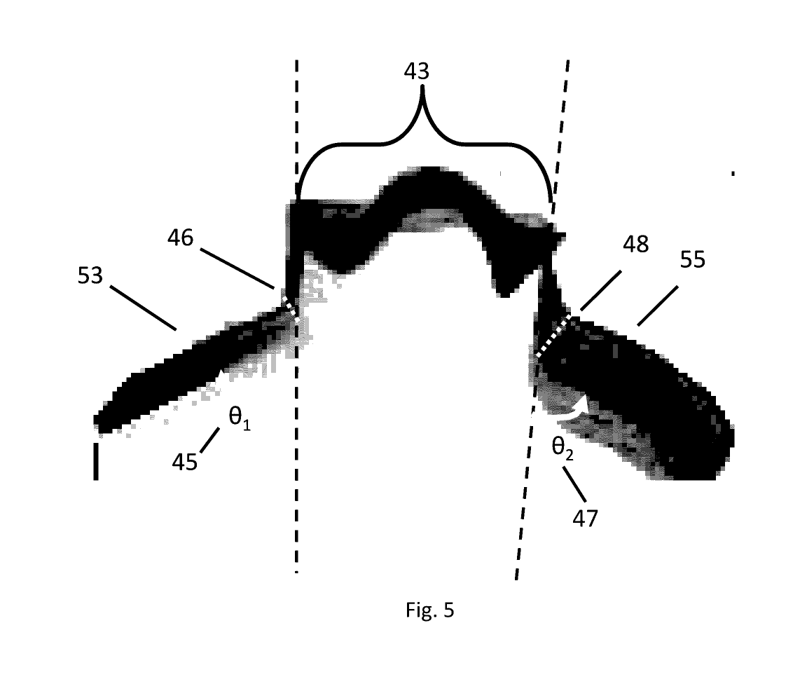

FIG. 5 shows how the exemplary first and third sections 53, 55 of the shade structure 41 may be angled with regards to the second section 43 of the shade structure 41. The first and second sections 53, 43 are formed with a first interface section 46 so that the first section 53 extends away from the second section 43 at a first angle θ₁ 45 that is less than 180 degrees. The second and third sections 43, 55 are formed with a second interface section 48 so that said third section 55 extends away from the second section 43 at a second angle θ₂ 47 that is less than 180 degrees.

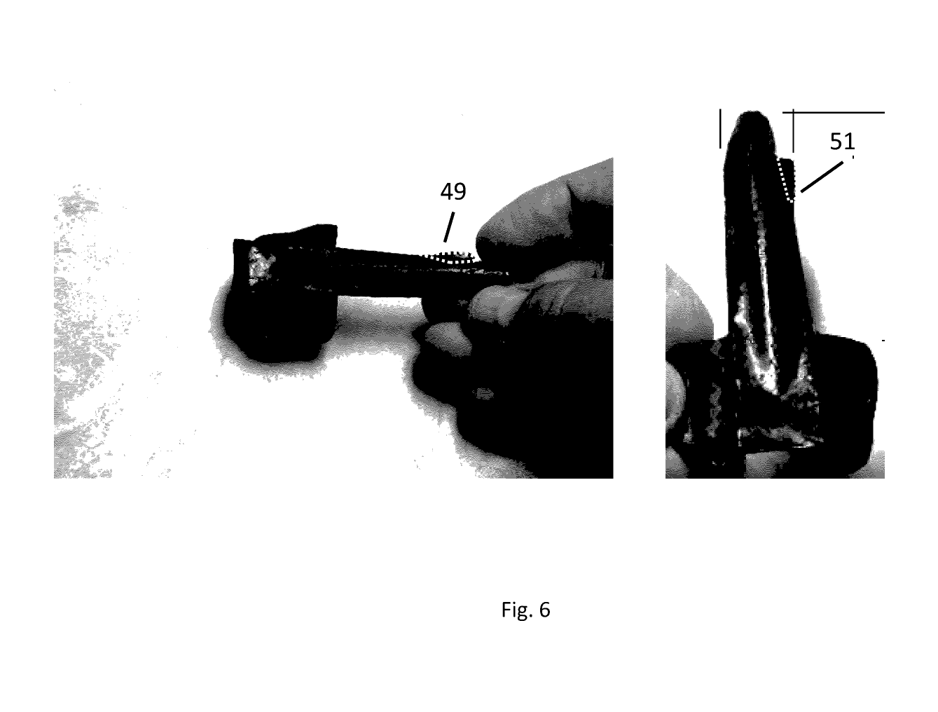

FIG. 6 shows an exemplary first and a second extended section 49, 51 of the second section 43 of the shade structure 41. The first and second sections can improve stability of the shade structure by providing surface contour and additional contact with the sight assembly 1.

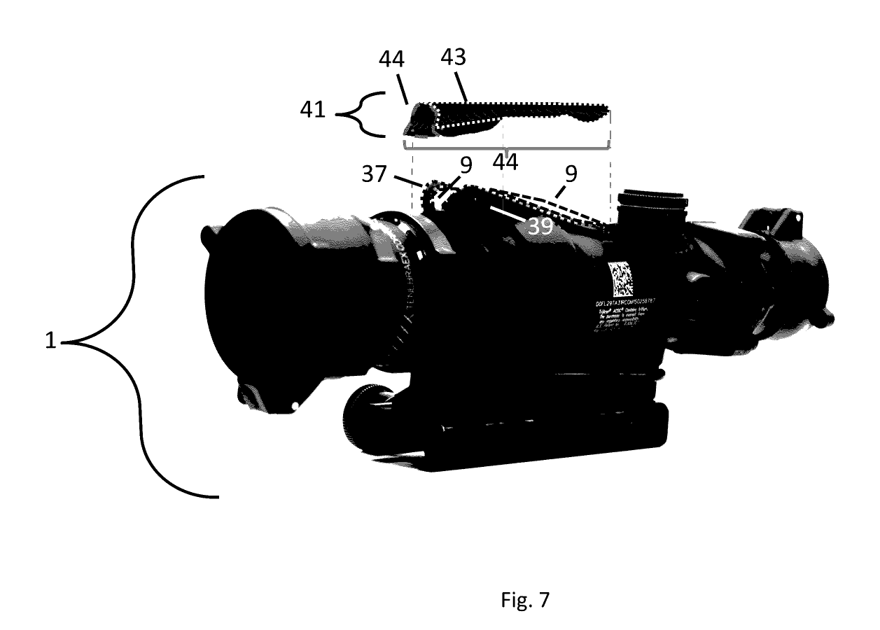

FIG. 7 shows the exemplary shade structure 41 can be disposed in the exemplary first position above the exemplary sight assembly 1. From the first position, the shade structure 41 can be lowered into a second position where the shade structure 41 covers the fiber optic line 9 and contacts the first and second wall sections 37, 39. In the second position, an inner surface 44 of the second element 43 touches and conforms to the first wall section 37, the second wall section 39, and the fiber optic line 9, creating a first gripping force that prevents the shade structure 41 from shifting while in the second position.

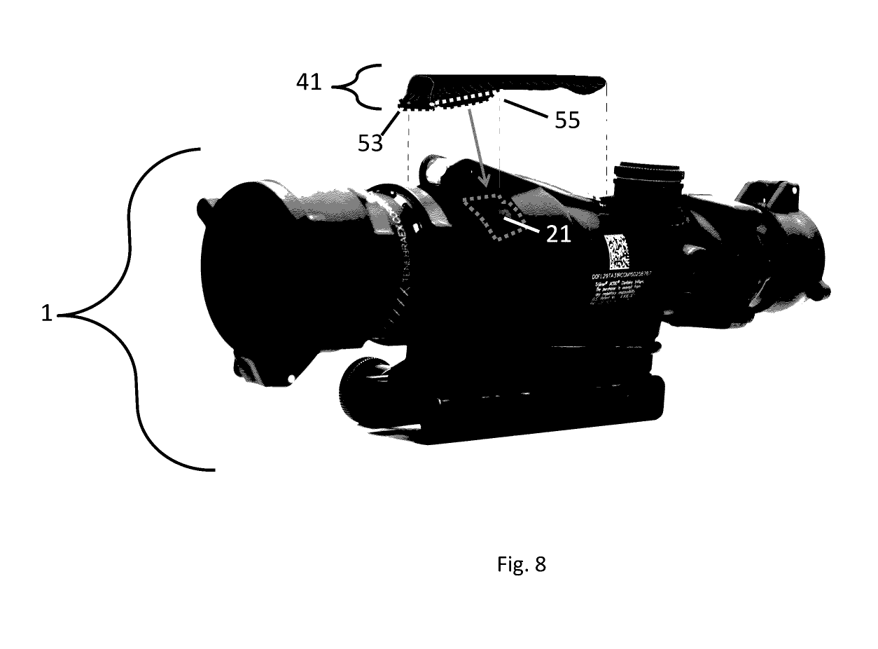

FIG. 8 shows the exemplary third section 55 and a portion of the first section 53 of the shade structure 41. FIG. 8 further shows an exemplary first contact location 21 on the sight housing 5 that the third section 55 can conform to when in the second position. An exemplary second contact location 19 (not shown in FIG. 8), that the first section 53 can conform to, is located on an opposing side of the sight housing 5. The first and second exemplary contact locations 21, 19 may be, but are not necessarily, recesses that the first and third sections 53, 55 can be press-fitted into.

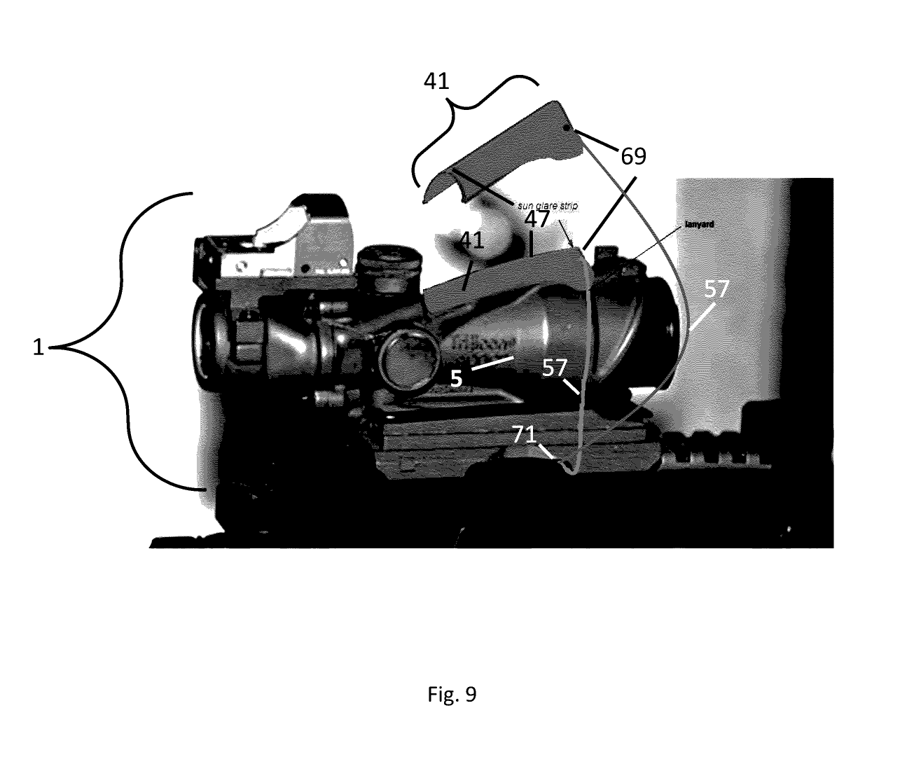

FIG. 9 shows another exemplary sight assembly 1 that the shade structure 41 may be used with, along with the shade structure 41 and a suggested location for placing the shade structure 41 to effectively control brightness of a sigh reticle 61. The shade structure can be designed such that the second section 43 further comprises an opaque section 47 that parallels the fiber optic line 9 when the shade structure 41 is in the second position.

The FIG. 9 exemplary opaque section 47 can be designed to limit the amount of ambient light 59 that reaches the fiber optic line 9 based on material choices. The exemplary opaque section 47 can be created during the manufacturing process using a lighter color resin augmented by an alternate pre-impregnated composite fiber material.

An exemplary modification to the shade structure 41 can include the addition of a lanyard 57 to secure the shade structure 41 to the sight assembly 1 in case the shade structure 41 pops off or is dropped by a user. A hole can be formed or drilled in the shade structure 41 to create a lanyard-shade connection 69. A similar hole can be drilled into the sight assembly to create a lanyard-sight connection 71.

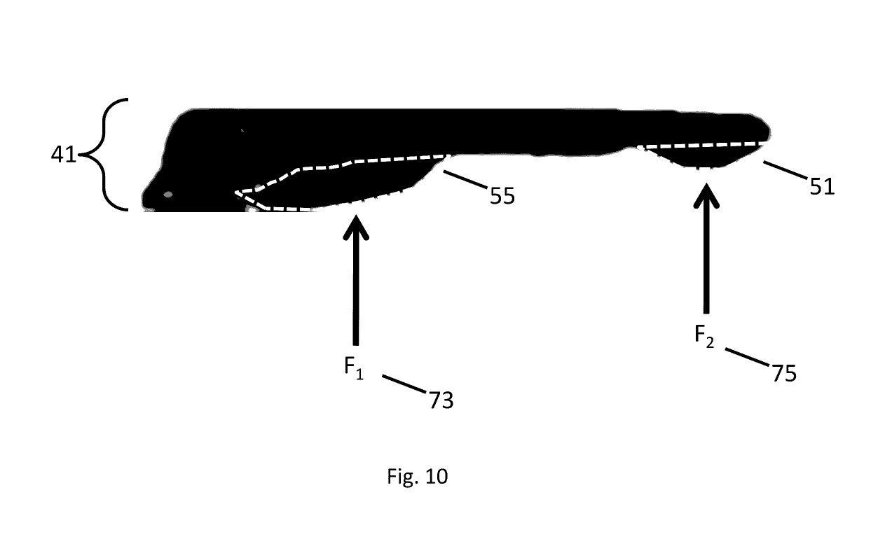

FIG. 10 shows where a force F₁ 73 can be applied to the third section 55 of the shade structure 41 to disengage the shade structure from the sight assembly 41. The force F₁ 73 can also be applied to the first section 53 (not shown in FIG. 10) of the shade structure 41 to disengage the shade structure 41.

FIG. 10 further shows where an exemplary force F₂ 75 can be applied to the second extended section 51 of the second section 43 of the shade structure 41 to disengage the shade structure from the sight assembly 41. The shade structure 41 may also be disengaged from the sight assembly 1 by applying the force F₂ 75 to the first extended section 49 (not shown in FIG. 10).

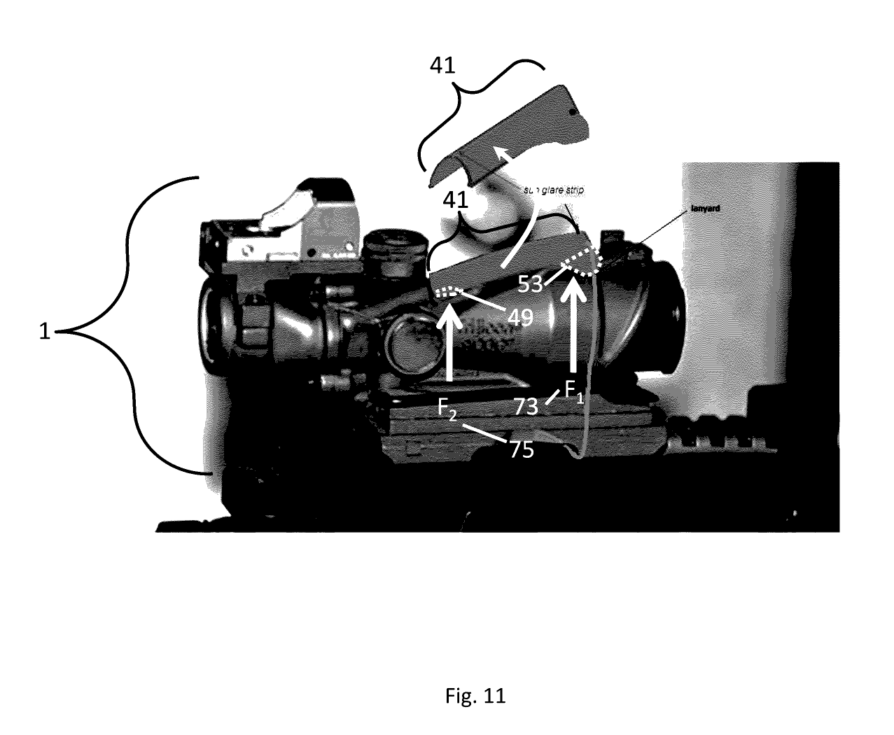

FIG. 11 shows exemplary sight assembly 1 that the shade structure 41 can attach to and the shade structure 41 in the first position, not attached to the sight assembly 1, and the second position, attached to the sight assembly. When the shade structure is in the second position, attached to the sight assembly 1, the user can apply a force F₁ 73 to either the first or third sections 53, 55 of the shade structure or a force F₂ 75 to either the first or second extend elements 49, 51 of the second section 43. The application of either F₁ 73 or F₂ 75 can cause the shade structure 41 to disengage the sight assembly 1.

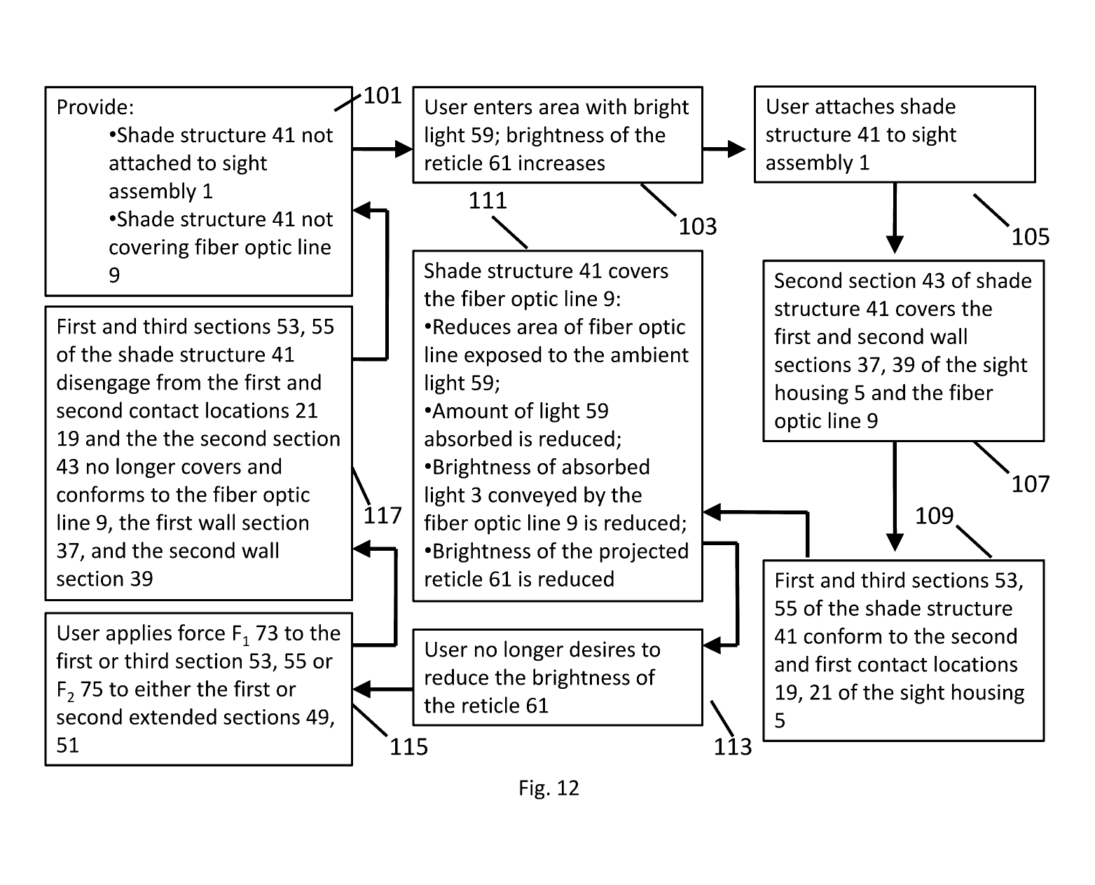

FIG. 12 shows a first exemplary method for using the shade structure 41 to control brightness of the reticle 61. Providing that the shade structure 41 is not attached to the sight assembly 1, and therefore not covering the fiber optic line 9, 101, the user may enter into an area of brighter ambient light 59 that causes the brightness of the reticle 61 to increase 103. To decrease the brightness of the reticle 61, the user attaches the shade structure 41 to the sight assembly 1, 105. The second section 43 of the shade structure 41 covers and conforms to the first and second wall section 37, 39 of the sight housing 5 and to the fiber optic line 9, 107. The first and third sections 53, 55 of the shade structure 41 conform to the second and first contact locations 19, 21 of the sight housing 5, 109. The shade structure 41 is now covering the fiber optic line 9, reducing area of the fiber optic line 9 exposed to the light 59 and thus reducing the amount of light 59 that the fiber optic line 9 can absorb reducing the brightness of the reticle 61, 111. When the user no longer desires to reduce the brightness of the reticle 113, the user can apply the force F₁ 73 to the first section 53 or the third section 55 or the user can apply the force F₂ 75 to the first extended section 49 or the second extended section 51, 115. The application of either force F₁ 73 or F₂ 75 causes the shade structure 41 to disengage from the sight assembly 1; the first and third sections 53, 55 of the shade structure 41 disengage from the first and second contact locations 21, 19, and the second section 43 of the shade structure 41 no longer covers and conforms to the fiber optic line 9, the first wall section 37, and the second wall section 39, 117. The shade structure 41 is no longer attached to the sight assembly 1 and is not covering the fiber optic line 9, 101.

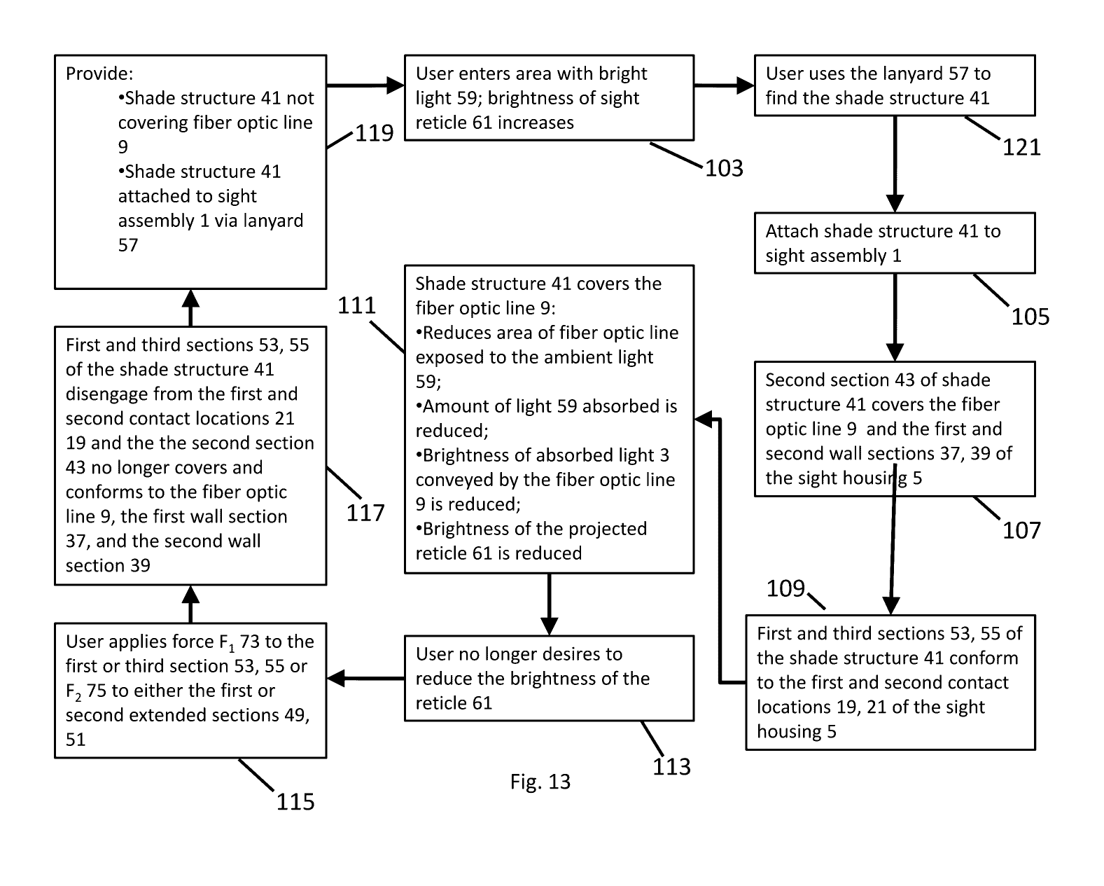

FIG. 13 shows a second exemplary method for using the shade structure 41 to control brightness of the reticle 61. Providing that the shade structure 41 can only attached to the sight assembly via a lanyard 57, and therefore not covering the fiber optic line 9, 119, the user may enter into an area of bright light 59 that causes the brightness of the reticle 61 to increase 103. The user uses the lanyard 57 to find the shade structure 41, 121 and then attaches the shade structure 41 to the sight assembly 1, 105. The second section 43 of the shade structure 41 covers and conforms to the first and second wall section 37, 39 of the sight housing 5 and to the fiber optic line 9, 107. The first and third sections 53, 55 of the shade structure 41 conform to the second and first contact locations 19, 21 of the sight housing 5, 109. The shade structure 41 is now covering the fiber optic line 9, reducing area of the fiber optic line 9 exposed to the light 59, which reduces the amount of light 59 that the fiber optic line 9 can absorb and thus reduces the brightness of the reticle 61, 111. When the user no longer desires to reduce the brightness of the reticle 113, the user can apply the force F₁ 73 to the first section 53 or the third section 55 of the shade structure 41, or the user can apply the force F₂ 75 to the first extended section 49 or the second extended section 51 of the second section 43 of the shade structure 41, 115. The application of either force F₁ 73 or F₂ 75 causes the shade structure 41 to disengage from the sight assembly 1; the first and third sections 53, 55 of the shade structure 41 disengage from the first and second contact locations 21, 19, and the second section 43 of the shade structure 41 no longer covers and conforms to the fiber optic line 9, the first wall section 37, and the second wall section 39, 117. The shade structure 41 is now only attached to the sight assembly 1 by the lanyard 57 and is not covering the fiber optic line 9, 101.

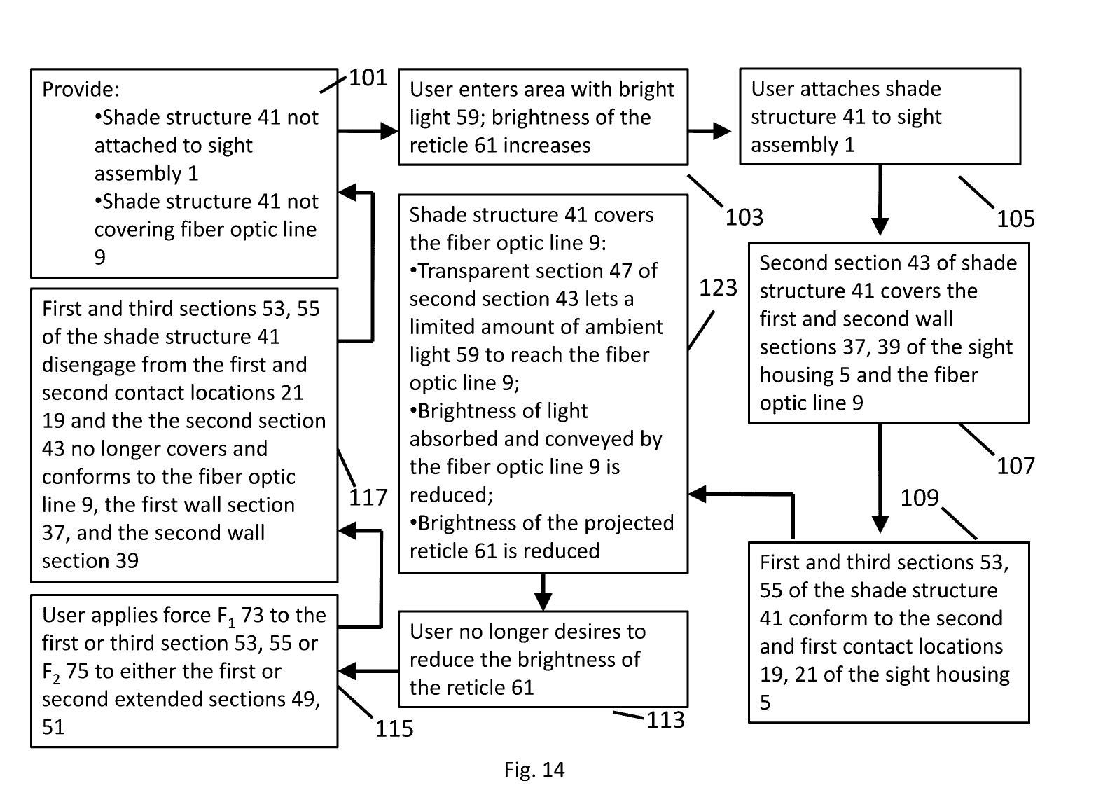

FIG. 14 shows a third exemplary method for using the shade structure 41 to control brightness of the reticle 61. The third method is comprised of the same steps as the first method, however the brightness of the reticle 9 is controlled by a different means. In the third method, brightness of the reticle 61 can be controlled by using the opaque section 47 of the second section 43 of the shade structure 41 that lets a limited amount of ambient light 59 to be absorbed and conveyed by the fiber optic line 9 to be subsequently projected as the reticle 61 onto the first lens 13, 123.

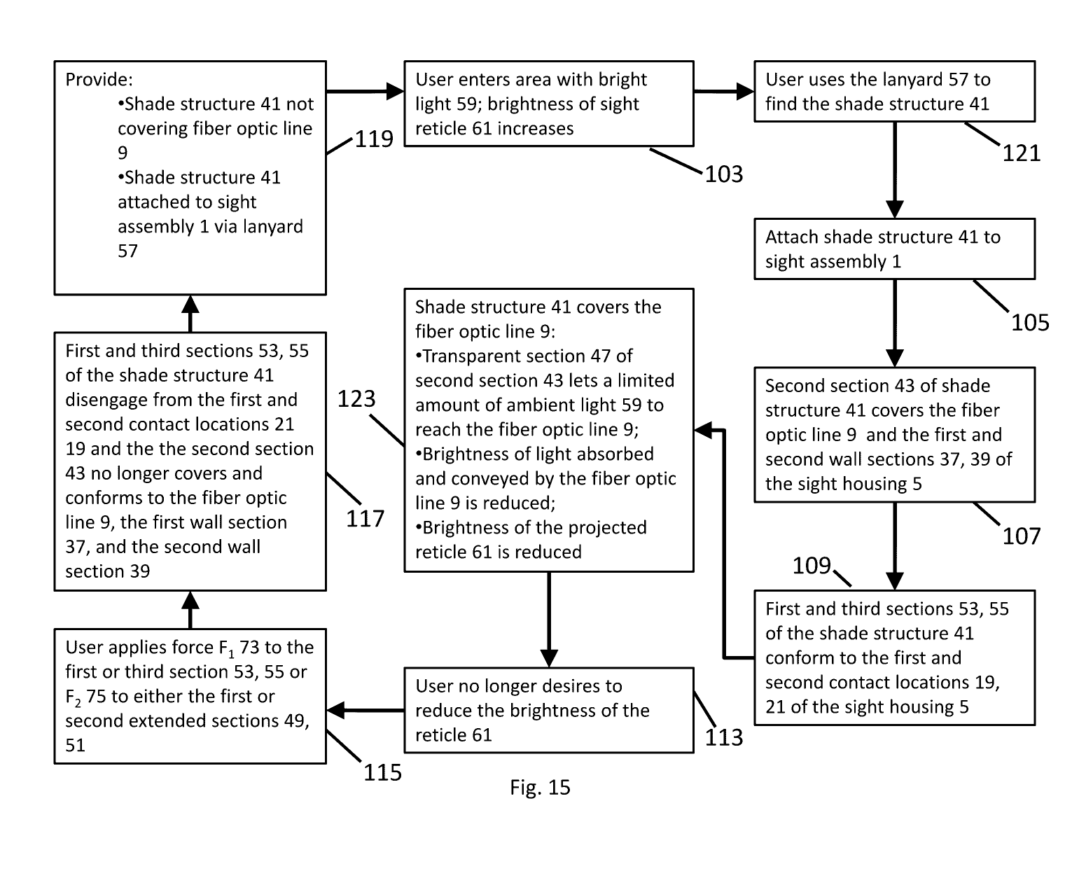

FIG. 15 shows a fourth exemplary method for using the shade structure 41 to control brightness of the reticle 61. The fourth method is comprises the same steps as the second method, however the brightness of the reticle 9 is controlled by the same means as method 3, brightness of the reticle 61 is controlled by using the opaque section 47 of the second section 43 of the shade structure 41 that lets a limited amount of ambient light 59 to be absorbed and conveyed by the fiber optic line 9 to be subsequently projected as the reticle 61 onto the first lens 13, 123.

Another embodiment can include a coating which can minimize sound of the light obscuring structure or cover striking another surface such an equipment item or weapon the cover or light obscuring structure strikes upon rapid removal from the equipment item or weapon via, e.g. a finger movement. Such coating can include rubber or other coatings which reduce noise generated from contact with another structure. Such finger movements can be done with no or minimal repositioning of the user's hand on the equipment item or weapon due to forming of the cover or light obscuring structure with flanges, stand-off sections, and/or sections within a range of motion of the user's hand grip positions on the equipment or weapon.

Although the invention has been described in detail with reference to certain preferred embodiments, variations and modifications exist within the spirit and scope of the invention as described and defined in the following claims.

1. A sight assembly comprising:
a sight comprising a sight housing, a mounting section formed onto a first sight housing section adapted to couple said sight assembly with another structure, a fiber optic housing comprising a first and second wall section formed on and extending away from a second sight housing section, a fiber optic line disposed between said first and second wall sections and extending into said sight housing through an aperture in said sight housing, a plurality of lenses comprising at least a first lens disposed within a hollow cavity of said sight housing along an optical axis, wherein said fiber optic line is adapted to convey light from an external section of said sight into said hollow cavity of said sight onto said first lens; and
a light obscuring cover comprising a first, second, and third section;
wherein said second section is formed in a shape conforming to and adapted for covering an external section of said fiber optic line and at least some of said first and second wall sections of said fiber optic housing section;
wherein said first and second sections are formed with a first interface section which comprises a first angled section of said cover formed so that said first section extends away from said second section at a first angle that is less than 180 degrees;
wherein said second and third sections are formed with a second interface section which comprises a second angled section of said cover formed so that said third section extends away from an opposing side of said second section at a second angle that is less than 180 degrees;
wherein at least said first and third sections are formed such that they mechanically couple with said fiber optic housing sides with a flexible interference fit adapted to grip said fiber optic housing up to a first friction force.

2. A sight assembly as in claim 1, wherein said first and second wall sections each respectively comprise a first and second recess section formed to respectively receive at least a portion of said first and second interface sections of said second section of said light obscuring device.

3. A sight assembly as in claim 1, wherein said second section of said light obscuring cover further comprises a first and second extended section that respectively form a first and second gap between said second section of said light obscuring cover and said first and second wall sections, wherein said first and second extended sections are located on a portion of said second section that lies near said aperture of said sight housing when said light obscuring cover is attached and conforming to said sight and fiber optic line.

4. A sight assembly as in claim 1, wherein said sight housing further comprises a third and fourth recessed section respectively formed on opposing sides of said fiber optic housing and adapted to receive said first and third section of said light obscuring cover such that said first and third sections of said light obscuring cover are flush with sides of said sight housing extending away from said third and fourth recesses, said third and four recess are further formed such that when said light obscuring cover is press fitted onto said fiber optic housing as far as said light obscuring cover can be fitted onto said housing, said first and third sections are disposed to respectively form a third and fourth gap between floor sections of said third and fourth recesses and respective sides of said first and third sections facing said third and fourth recesses.

5. A sight assembly as in claim 1, wherein said second section of said light obscuring cover further comprises an opaque section that parallels said fiber optic line when said light obscuring cover is attached and conforming to said sight and fiber optic line.

6. A sight assembly as in claim 1, wherein said light obscuring cover comprises carbon fiber and resin.

7. A sight assembly as in claim 1, wherein said first and second angles are greater than 35 degrees and less than 70 degrees.

8. A sight assembly as in claim 1, wherein said sight assembly further comprises:
a lanyard
wherein said sight further comprising a first lanyard connection, wherein said light obscuring device further comprising a second lanyard connection, said lanyard is coupled with said light obscuring device at said first and second lanyard connection.

9. A sight assembly comprising:
a lanyard; and
a sight comprising a sight housing, a sight-lanyard connection, a mounting section formed onto a first sight housing section adapted to couple said sight assembly with another structure, a fiber optic housing comprising a first and second wall section formed on and extending away from a second sight housing section, a fiber optic line disposed between said first and second wall sections and extending into said sight housing through an aperture in said sight housing, a plurality of lenses comprising at least a first lens disposed within a hollow cavity of said sight housing along an optical axis, wherein said fiber optic line is adapted to convey light from an external section of said sight into said hollow cavity of said sight onto said first lens, said sight housing further comprises a third and fourth recessed section respectively formed on opposing sides of said fiber optic housing and adapted to receive said first and third section of a light obscuring cover such that a first and third section of said light obscuring cover are flush with sides of said sight housing extending away from said third and fourth recessed sections, said third and fourth recessed sections are further formed such that when said light obscuring cover is press fitted onto said fiber optic housing as far as said cover can be fitted onto said housing, said first and third sections are disposed to respectively form a third and fourth gap between floor sections of said third and fourth recessed sections and respective sides of said first and third sections facing said third and fourth recessed sections;
wherein said light obscuring cover comprising said first and third sections, a second section, and a light obscuring cover-lanyard connection;
wherein said second section is formed in a shape conforming to and adapted for covering an external section of said fiber optic line and at least some of said first and second wall sections of said fiber optic housing section, said second section of said light obscuring cover further comprises a first and second extended section that respectively form a first and second gap between said second section of said light obscuring cover and said first and second wall sections;
wherein said first and second extended sections are located on a portion of said second section that lies near said aperture of said sight housing when said light obscuring cover is attached and conforming to said sight and fiber optic line;
wherein said first and second sections are formed with a first interface section which comprises a first angled section of said cover formed so that said first section extends away from said second section at a first angle that is greater than 35 degrees and less than 70 degrees;
wherein said second and third sections are formed with a second interface section which comprises a second angled section of said cover formed so that said third section extends away from an opposing side of said second section at a second angle that greater than 35 degrees and less than 70 degrees;
wherein at least said first and third sections are formed such that they mechanically couple with said fiber optic housing sides with a flexible interference fit adapted to grip said fiber optic housing up to a first friction force;
wherein said light obscuring cover is made of carbon fiber and resin.

10. A method for using a light obscuring cover to control brightness of a sight assembly comprising:
providing said sight assembly comprising:
a sight comprising:
a sight housing, a mounting section formed onto a first sight housing section adapted to couple said sight assembly with another structure, a fiber optic housing comprising a first and second wall section formed on and extending away from a second sight housing section, a fiber optic line disposed between said first and second wall section and extending into said sight housing through an aperture in said sight housing, a plurality of lenses comprising a first lens disposed within a hollow cavity of said sight housing along an optical axis,
wherein said fiber optic line is adapted to convey light from an external section of said fiber optic line disposed within said first and second wall sections into said hollow cavity onto said first lens;
a light obscuring cover comprising a first, second, and third section;
wherein said second section is formed in a shape conforming to and adapted for covering an external section of said fiber optic line and at least some of said first and second wall sections of said fiber optic housing section;
wherein said second further comprises a first and second extended section that respectively form a first and second gap between said second section of said light obscuring cover and said first and second wall sections;
wherein said first and second extended sections are located on a portion of said second section that lies near said aperture in said sight housing when said light obscuring cover is attached and conforming to said sight and fiber optic line;
wherein said first and second sections are further formed with a first interface section which comprises a first angled section of said cover formed so that said first section extends away from said second section at a first angle that is less than 180 degrees;
wherein said second and third sections are formed with a second interface section which comprises a second angled section of said cover formed so that said third section extends away from an opposing side of said second section at a second angle that is less than 180 degrees;
wherein at least said first and second interface sections are formed such that they mechanically couple with said fiber optic housing sides with a flexible interference fit adapted to grip said fiber optic housing up to a first friction force;
providing said light obscuring cover is not attached and not conforming to said sight;
attaching said light obscuring cover to said sight comprising:
placing said second section of said light obscuring cover onto said sight such that said second section covers and conforms to said first and second wall sections of said fiber optic housing and to said fiber optic line;
placing said first and third sections of said light obscuring cover onto said sight such that said first and third sections conform to said sight housing and thereby reducing an amount of said fiber optic line exposed to ambient light; and
disengaging said light obscuring device from said sight comprising:
applying either a first upward force to said first or third section of said light obscuring cover or a second upward force to said first or second extended sections of said second section of said light obscuring cover;
disengaging said first and third sections of said light obscuring cover from said sight housing;
disengaging said second section of said light obscuring device from said fiber optic line and said first and second wall sections of said fiber optic housing and thereby increasing amount of said fiber optic line exposed to ambient light, increasing amount of said ambient light absorbed by said fiber optic line, and then increasing brightness of said reticle.

11. A method as in claim 10 further comprising:
providing a lanyard, wherein said sight further comprising a first lanyard connection, said light obscuring device further comprising a second lanyard connection, said lanyard is coupled to said first lanyard connection and said second lanyard connection;
wherein said light obscuring cover is fall or trajectory from said sight assembly is arrested by said lanyard after said user disengages said light obscuring device from said sight.

12. A method as in claim 10 further comprising:
wherein said second section of said light obscuring cover further comprising an opaque section that parallels said fiber optic line when said light obscuring cover is attached and conforming to said sight and fiber optic line;
covering said fiber optic line with said light obscuring device such that over fifty percent of said ambient light must pass through said opaque section prior to being absorbed by said fiber optic line.
